(19) United States
(12) Patent Application Publication
(10) Pub. No.: US 2020/0232853 A1
(43) Pub. Date: Jul. 23, 2020

(54) NON-CONTACT TYPE INFRARED TEMPERATURE SENSOR MODULE

(71) Applicant: LG ELECTRONICS INC., Seoul (KR)

(72) Inventors: Hyojin Nam, Seoul (KR); Kyoungwoo Jo, Seoul (KR); Mangeun Kim, Seoul (KR); Seungwoo Ham, Seoul (KR)

(73) Assignee: LG ELECTRONICS INC., Seoul (KR)

(21) Appl. No.: 16/305,747

(22) PCT Filed: Aug. 24, 2016
(86) PCT No.: PCT/KR2016/009396

§ 371 Date: Nov. 29, 2018

(30) Foreign Application Priority Data
May 30, 2016 (KR) 10-2016-0066610
Aug. 5, 2016 (KR) 10-2016-0100194

(51) Int. Cl. G01J 5/20; G01J 5/08

(52) U.S. Cl. CPC G01J 5/20; G01J 2005/202; G01J 5/0803

(57) ABSTRACT

A non-contact type infrared temperature sensor module according to an embodiment of the present invention can comprise: a case of which a portion of an upper surface is opened and having an accommodation space formed therein; a base having an upper surface coupled to the case; a cover window provided on the upper surface of the case and sealing the opened portion of the case; an infrared temperature sensor provided on the upper surface of the base and sensing the temperature of an object by receiving light transmitted from the cover window; and a first capping unit coupled to an upper portion of the infrared temperature sensor and blocking heat transmitted from the accommodation space.

### TECHNICAL FIELD

The present invention relates to a non-contact type infrared temperature sensor module, and more particularly, to a temperature sensor module for preventing a temperature change due to other factors except for infrared rays to improve accuracy in temperature measurement.

### BACKGROUND ART

In general, measuring of a temperature has a close relationship with our lives, such as indoor heating and cooling or cooking.

Needless to say, there is a need for public and industrial use.

A method for measuring a temperature may be classified into contact type and non-contact type.

However, in general, measuring of a temperature is performed mostly in the contact type, and the non-contact type is merely an auxiliary means when contact is impossible.

For example, the non-contact type has been used only in the case of a rotating object to be measured, a moving object to be measured, and an object to be measured, which is not contactable at a very high temperature.

Also, since the non-contact type is expensive and difficult to be handled, the contact type is more widely used than the non-contact type.

However, in recent years, there has been an increase in demands for the non-contact type, and particularly in measurement of a relatively low temperature range of about 0° C. to about 300° C., there is a growing demand for a simple and inexpensive radiation thermometer.

Such a non-contact type radiation thermometer may simplify the circuit configuration and make it possible to purchase an infrared sensor (IR sensor) used in a radiation thermometer at a lower cost than the radiation thermometer according to the related art. In some cases, it became more economical than the contact type.

In recent years, there are a photonic type sensor using a photovoltaic effect or a photoconductive effect, a bolometer, a pyroelectric sensor, and a thermal type sensor such as a thermopile sensor as the sensor for sensing radiant energy.

The photonic type sensor utilizes a change in electrical characteristic of the sensor by exciting electrons through incident radiation. In general, detection performance is very good in a selected wavelength range and exhibits fast responsivity.

However, there is a disadvantage that the related process technology is not yet established, the prices is high, and it has to operate at a temperature less than a liquid-N₂ temperature so as to obtain predetermined infrared sensitivity.

Thus, a cooling-free, low-cost, and reliable device is required to utilize commercial and industrial infrared sensors.

Recently, a thermal type sensor capable of satisfying these characteristics has been actively studied.

As a result of these studies, devices that provide useful information of an object, which is unknown through a visible image, so as to be used in fields of production examination, process monitoring, noncontact and non-destructive testing have been developed.

Among these devices, Hg, Cd and Te are the most excellent materials up to date, but the manufacturing technology for mass production has not yet matured, and the price and uniformity of a substrate have become a problem.

Thus, a thermopile sensor capable of being manufactured by a semiconductor process that has been established while satisfying the above problems has been actively studied.

The thermopile sensor refers to a sensor having a structure made of two different materials, one of which forms a junction and the other of which is opened and utilizing a seebeck effect in which thermoelectric power is generated in comparison to a temperature difference when the temperature difference occurs between the junction portion and the opened portion.

FIGS. 1A and 1B are plan and cross-sectional views of a thermopile sensor according to the related art. In a structure as illustrated in FIGS. 1A and 1B, thermocouples are connected in series to each other, each of elements of the thermocouples has large thermoelectric power, and the elements of the thermocouples are made of materials having polarities opposite to each other.

Also, the thermocouples are located at an intersection of a hot region and a cold region, and a hot junction and a cold junction are thermally isolated from each other.

In general, the cold junction is located on a silicon substrate for efficient heat sinking and forms a black body that absorbs infrared radiation at the hot junction.

That is, two different thermoelectric materials are disposed in series on a thin diaphragm with low thermal conductance and low thermal capacitance.

The thermopile sensor has a stable response characteristic against DC radiation and has a merit that it responds to a wide infrared spectrum and does not require a bias voltage or bias current.

FIGS. 2A to 2F cross-sectional views illustrating a process of manufacturing the thermopile sensor according to the related art. As illustrated in FIG. 2A, a silicon substrate having a (100) crystal direction is selected as a substrate 1.

This is because back-side etching, which is a post-process, has to be considered.

Also, a first oxide layer is deposited to a thickness of about 2000 Å on each of both sides of the substrate 1 by thermal oxidation, and a nitride layer 3 is deposited to a thickness of 3000 Å on the first oxide layer 2 by low pressure chemical vapor deposition (LPCVD).

Here, the nitride layer 3 is used as an etch mask when the substrate 1 is etched and is an etching stop layer for stopping the etching.

Then, as illustrated in FIG. 2B, a second oxide layer 4 is deposited to a thickness of 7000 Å on the nitride layer 3 by the low pressure chemical vapor deposition.

As described above, formation of the oxide/nitride/oxide (ONO) structure compensates internal residual stress of each of diaphragms when the diaphragms are formed, to obtain the mechanically stable diaphragms.

That is, the general oxide layer has compressive stress, and the LPCVD nitride layer has tensile stress. Thus, a structure that is capable of compensating the stress may be provided.

As described above, after the diaphragms are formed, as illustrated in FIG. 2C, first and second thermocouple materials 5 are sequentially deposited on the second oxide layer 4 disposed on the substrate 1 and then patterned.

Here, the thermocouple materials 5 have to be composed of materials having a large seebeck coefficient therebetween so that the sensor characteristics are good.

Also, as illustrated in FIG. 2D, a protection layer 6 for protecting the sensor device against external environments is formed on an entire surface including the thermocouple material 5, and a pad 7 is formed to contact the thermocouple material so as to connect an output that is outputted from the sensor to an external circuit.

Then, as illustrated in FIG. 2E, a bottom surface of the silicon substrate 1 is etched to expose the diaphragm.

Here, the used etch solution is an aqueous solution of potassium hydroxide (KOH), which is hardly etched in a (111) direction with respect to a crystal direction of the silicon, and thus, the substrate 1 is etched on the bottom surface thereof in a direction that is inclined at an angle of 54.74°.

Also, since the silicon nitride layer 3 is hardly etched by the aqueous solution of potassium hydroxide, the silicon nitride layer 3 is used as the etch mask and also used as an etch stop layer for solving the problem of etch surface non-uniformity in which the entire substrate 1 is not simultaneously etched when the etching is stopped.

Also, as illustrated in FIG. 2F, a black body 8 is formed on the protection layer 6.

However, since the thermopile sensor according to the related art does not block heat transferred from the outside, there is a disadvantage that a large error in temperature measurement using infrared rays occurs.

### DISCLOSURE OF THE INVENTION

### Technical Problem

One aspect of the present invention is to provide a non-contact type infrared temperature sensor module having improved accuracy in temperature measurement.

Another aspect of the present invention is to provide a non-contact type infrared temperature sensor module in which a capping device is coupled to a top surface of an infrared temperature sensor to block heat transferred from an accommodation space within a cover.

Further another aspect of the present invention is to provide a non-contact type infrared temperature sensor module in which a capping device is disposed in the vicinity of a bottom surface of an infrared temperature sensor to additionally block heat transferred from a base.

### Technical Solution

A non-contact type infrared temperature sensor module according to an embodiment of the present invention includes a case of which a portion of a top surface is opened and which has an accommodation space therein, a base having a top surface coupled to the case, a cover window installed on the top surface of the case and configured to seal the opened portion of the case, an infrared temperature sensor configured to detect a temperature by receiving light transmitted from the cover window, and a first capping unit coupled to an upper portion of the infrared temperature sensor.

The non-contact type infrared temperature sensor module according to an embodiment of the present invention may further include a single processing circuit electrically connected to the infrared temperature sensor to receive and process a signal of the temperature detected by the infrared temperature sensor, wherein the first capping unit and the infrared temperature sensor may be connected to each other through a bonding unit.

The non-contact type infrared temperature sensor module according to an embodiment of the present invention may further include a second capping unit coupled to a lower portion the infrared temperature sensor.

In the non-contact type infrared temperature sensor module according to an embodiment of the present invention, the infrared temperature sensor may be connected to the top surface of the base and forms the accommodation space, and the non-contact type infrared temperature sensor module may further include a third capping unit coupled to the top surface of the base in the accommodation space of the infrared temperature sensor.

The non-contact type infrared temperature sensor module according to an embodiment of the present invention may further include a metal plate coupled to a lower portion of the infrared temperature sensor and coupled to the top surface of the base.

In the non-contact type infrared temperature sensor module according to an embodiment of the present invention, an anti-reflection filter configured to prevent light in an infrared region from being reflected may be attached to the first capping unit.

A non-contact type infrared temperature sensor module according to an embodiment of the present invention includes a case of which a portion of a top surface is opened and which has an accommodation space therein, a base having a top surface coupled to the case, a cover window installed on the top surface of the case and configured to seal the opened portion of the case, a flip-chip type infrared temperature sensor configured to detect a temperature by receiving light transmitted from the cover window, and a first capping unit coupled to an upper portion of the infrared temperature sensor.

The non-contact type infrared temperature sensor module according to an embodiment of the present invention may further include a single processing circuit electrically connected to the infrared temperature sensor to receive and process a signal of the temperature detected by the infrared temperature sensor, wherein the first capping unit and the infrared temperature sensor may be connected to each other through a bonding unit, and the infrared temperature sensor and the base may be connected to each other through a metal bonding unit.

The non-contact type infrared temperature sensor module according to an embodiment of the present invention may further include a second capping unit coupled to a lower portion the infrared temperature sensor.

In the non-contact type infrared temperature sensor module according to an embodiment of the present invention, the infrared temperature sensor may be connected to the top surface of the base by using a bonding material and forms the accommodation space, and the non-contact type infrared temperature sensor module may further include a third capping unit coupled to the top surface of the base in the accommodation space of the infrared temperature sensor.

The non-contact type infrared temperature sensor module according to an embodiment of the present invention may further include a metal plate coupled to a lower portion of the infrared temperature sensor and coupled to the top surface of the base.

In the non-contact type infrared temperature sensor module according to an embodiment of the present invention, an anti-reflection filter configured to prevent light in an infrared region from being reflected may be attached to the first capping unit.

### Advantageous Effects

The present invention has the effects as follows.

According to an embodiment of the various embodiments of the present invention, there is an advantage of providing the non-contact type infrared temperature sensor module having the improved accuracy in temperature measurement.

According to another embodiment of the various embodiments of the present invention, there is a technical effect of providing the non-contact type infrared temperature sensor module in which the capping device is coupled to the top surface of the infrared temperature sensor to block the heat transferred from the accommodation space within the cover.

According to further another embodiment of the various embodiments of the present invention, there is a technical effect of providing the non-contact type infrared temperature sensor module in which the capping device is disposed in the vicinity of the bottom surface of the infrared temperature sensor to additionally block the heat transferred from the base.

### BRIEF DESCRIPTION OF THE DRAWINGS

FIGS. 1A and 1B are plan and cross-sectional views of a thermopile sensor according to the related art.

FIGS. 2A to 2F cross-sectional views illustrating a process of manufacturing the thermopile sensor according to the related art.

FIG. 3 is a view for explaining heat transfer in a general non-contact type infrared temperature sensor module.

FIG. 4 is a view for explaining a structure of a non-contact type infrared temperature sensor module according to an embodiment of the present invention.

FIG. 5 is a view for explaining a method for connecting an infrared temperature sensor to a capping unit in the non-contact type infrared temperature sensor module according to an embodiment of the present invention.

FIG. 6 is a view for explaining an example using a flip-chip type infrared temperature sensor in an infrared temperature sensor module according to another embodiment of the present invention.

FIG. 7 is a view for explaining an example in which the infrared temperature sensor module includes a first capping unit and a second capping unit according to an embodiment of the present invention.

FIG. 8 is a view for explaining another example in which the infrared temperature sensor module includes the first capping unit and the second capping unit according to an embodiment of the present invention.

FIG. 9 is a view for explaining an example in which the infrared temperature sensor module includes the first capping unit and a metal plate according to an embodiment of the present invention.

FIG. 10 is a view for explaining an example in which the infrared temperature sensor module includes a first capping unit and a second capping unit according to another embodiment of the present invention.

FIG. 11 is a view for explaining another example in which the infrared temperature sensor module includes the first unit and the second capping unit according to another embodiment of the present invention.

FIG. 12 is a view for explaining an example in which the infrared temperature sensor module includes the first capping unit and a metal plate according to another embodiment of the present invention.

FIGS. 13 and 14 are views for explaining an example in which an anti-reflection filter is attached to the first capping unit of the infrared temperature sensor module according to an embodiment of the present invention.

FIG. 15 is a view for explaining a first embodiment in which an infrared temperature sensor and a signal processing circuit are disposed on different surfaces of a base in the infrared temperature sensor module according to the present invention.

FIGS. 16A to 16H are views for explaining a process of manufacturing an infrared temperature sensor module in which an infrared temperature sensor and a signal processing circuit are disposed on different surfaces of a base according to the present invention.

FIG. 17 is a view for explaining a second embodiment in which an infrared temperature sensor and a signal processing circuit are disposed on different surfaces of a base in the infrared temperature sensor module according to the present invention.

FIG. 18 is a view for explaining a third embodiment in which an infrared temperature sensor and a signal processing circuit are disposed on different surfaces of a base in the infrared temperature sensor module according to the present invention.

FIGS. 19 and 20 are views for explaining a fourth embodiment in which an infrared temperature sensor and a signal processing circuit are disposed on different surfaces of a base in the infrared temperature sensor module according to the present invention.

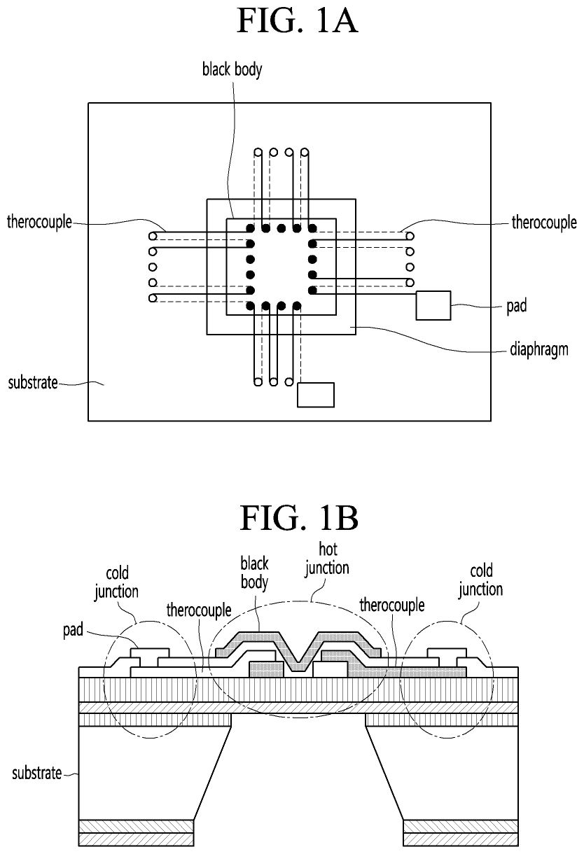

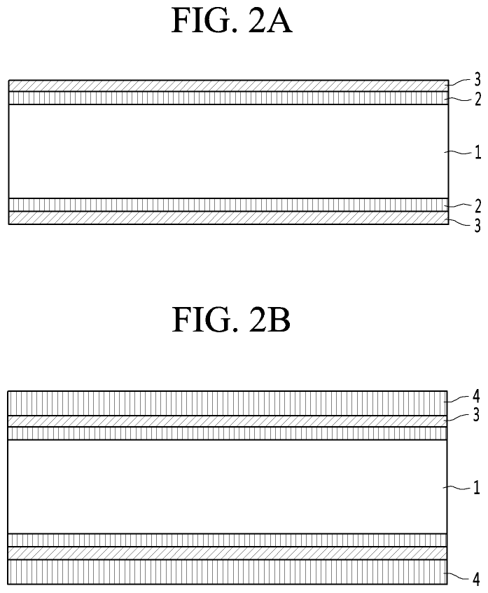

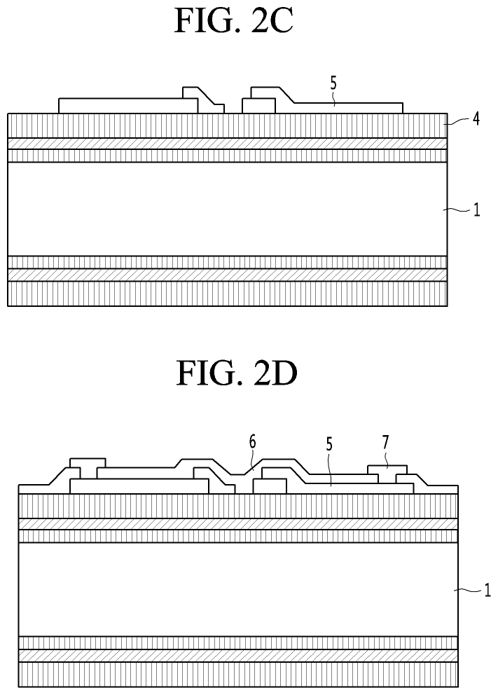

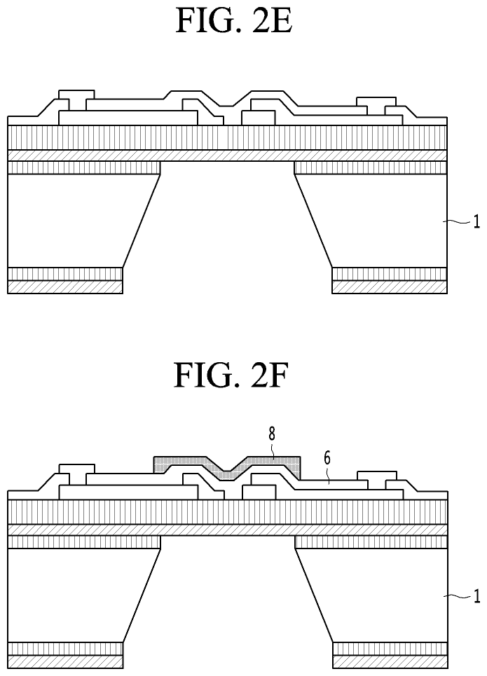

### MODE FOR CARRYING OUT THE INVENTION

Description will now be given in detail according to exemplary embodiments disclosed herein, with reference to the accompanying drawings. In general, a suffix such as “module” and “unit” may be used to refer to elements or components. Use of such a suffix herein is merely intended to facilitate description of the specification, and the suffix itself is not intended to give any special meaning or function.

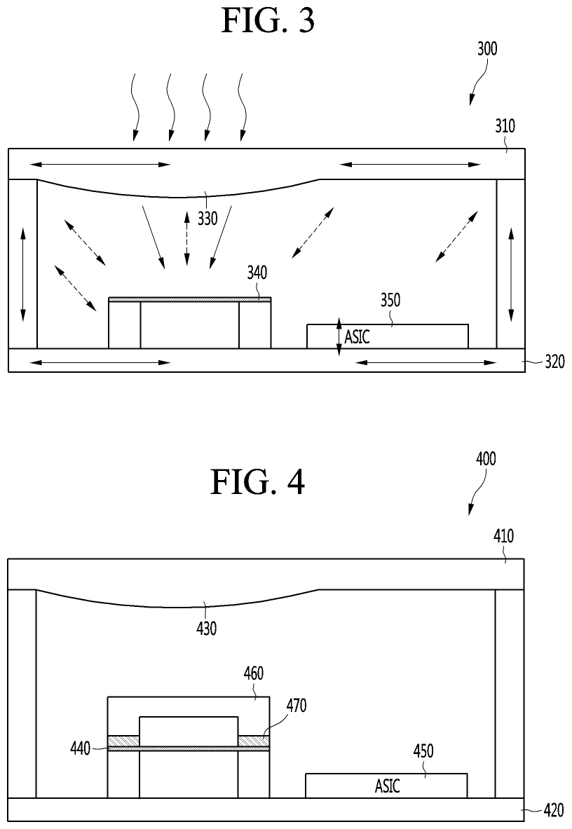

FIG. 3 is a view for explaining heat transfer in a general non-contact type infrared temperature sensor module.

As illustrated in FIG. 3, a general non-contact type infrared temperature sensor module 300 may include a case 310, a base 320, a cover window 330, an infrared temperature sensor 340, and a signal processing circuit 350.

First, since the case 310 directly contacts the outside, the case 310 may be affected by an external temperature and also be affected by solid heat transfer due to a temperature of the base 320 that is directly connected thereto. In this case, If a temperature difference between the external temperature and the temperature of the base 320 is large, the temperature of the case 310 may vary until a thermal equilibrium state is reached.

The infrared temperature sensor 340 detects a temperature through infrared rays inputted through the cover window 330. Here, it is most preferable to detect only a temperature change by the infrared rays without being influenced by other factors. However, as illustrated in FIG. 3, in the general non-contact infrared temperature sensor module 300, the infrared temperature sensor 340 is not only affected by the infrared rays inputted through the cover window 330 but also affected by all of air heat transfer in an accommodation space due to a temperature change of the case 310 and 1 of the influence heat transfer by the base 320. Thus, in such an environment, since the infrared temperature sensor 340 detects a temperature change due to other factors in addition to the temperature change detection by the infrared rays, accuracy in temperature measurement of an object to be measured may be deteriorated. Thus, a structure of a non-contact type infrared temperature sensor module according to an embodiment of the present invention, which additionally includes a capping device, will be described below in order to supplement the disadvantage of the general non-contact type temperature sensor module 300 as described above.

FIG. 4 is a view for explaining a structure of a non-contact type infrared temperature sensor module according to an embodiment of the present invention.

As illustrated in FIG. 4, a non-contact type infrared temperature sensor module 400 according to an embodiment of the present invention may include a case 410, a base 420, a cover window 430, an infrared temperature sensor 440, a signal processing circuit 450, and a capping unit 460. Furthermore, although not shown in FIG. 4, the non-contact type infrared temperature sensor module 400 according to an embodiment of the present invention may include a heat dissipation structure on a pad portion on which the infrared temperature sensor 440 and the signal processing circuit 450 are seated on the base 420 so as to accurately measure a temperature by minimizing an effect of heat generated in the infrared temperature sensor 440 and the signal processing circuit 450.

The case 410 of the non-contact type infrared temperature sensor module 400 according to an embodiment of the present invention has a top surface that is partially opened so that light is incident from the outside and is coupled to a top surface of the base 110 to form an accommodation space in which the cover window 430, the infrared temperature sensor 440, the signal processing unit 450, and the capping unit 460 are accommodated. Here, the case 410 and the base 420 may be coupled to each other to be sealed with respect to each other so as to prevent an internal temperature from increasing by an effect such as external air.

Although not shown in FIG. 4, the cover window 430 of the non-contact type infrared temperature sensor module 400 according to an embodiment of the present invention may include a lens or an infrared filter. The infrared filter is mounted inside an upper surface of the case 410 to filter light in an infrared region that is capable of being recognized by the infrared temperature sensor 440 from the light incident from the outside through the opening of the case 410 so as to transmit the light to the infrared temperature sensor 440. The cover window 430 of the non-contact type infrared temperature sensor module 400 according to an embodiment of the present invention may transmit a large amount of light incident through the opening of the case 410.

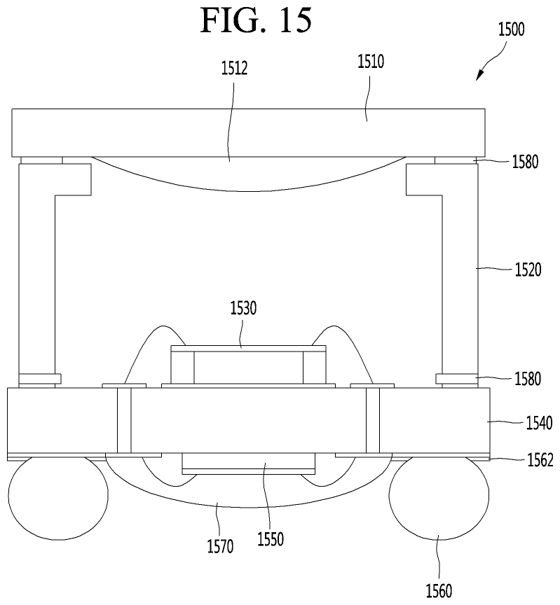

Also, embodiments in which the infrared temperature sensor and the signal processing circuit are coupled to the same surface of the base will be described with reference to FIGS. 4 to 12, and embodiments in which the infrared temperature sensor and the signal processing circuit are respectively coupled to different surfaces of the base will be described with reference to FIGS. 15 to 20.

The infrared temperature sensor 440 of the non-contact type infrared temperature sensor module 400 according to an embodiment of the present invention detects a temperature of the object by using the infrared light transmitted through the cover window 430. Although not shown in FIG. 4, the infrared temperature sensor 440 may be electrically connected to the signal processing circuit 450 through a wire or the like.

The signal processing circuit 450 of the non-contact type infrared temperature sensor module 400 according to an embodiment of the present invention is provided as an application specific integrated circuit (ASIC) such as a thermistor and electrically connected to the infrared temperature sensor 440. The signal processing circuit 450 of the non-contact type infrared temperature sensor module 400 according to an embodiment of the present invention processes the temperature detected by the infrared temperature sensor 440 to measure and compensate the temperature or convert the temperature into an electrical signal.

The capping unit 460 of the non-contact type infrared temperature sensor module 400 according to an embodiment of the present invention may be connected to the infrared temperature sensor 440 through a bonding unit 470. The bonding unit may be called a bonding material, a bonding layer, and the like. A glass frit bonding, metal bonding, or adhesive bonding manner may be used as the connection method using the bonding unit. An eutectic bonding (Au—Sn, Au—Si), transient liquid phase (TLP) bonding, or solder bonding manner may be used as the metal bonding manner, and a BCB or polyimide bonding manner may be used as the adhesive bonding manner.

The capping unit may be disposed on the top surface of the infrared temperature sensor 440 to allow a membrane of the infrared temperature sensor 440 to be prevented from being affected by heat transmitted from the accommodation space within the case 410. Also, the capping unit 460 may be manufactured as a device with good heat transfer and be designed to have the same temperature as that of the infrared temperature sensor 440. Thus, the capping unit 460 may have a technical effect of minimizing an influence of the external temperature on the membrane of the infrared temperature sensor 440.

As illustrated in FIG. 4, when the capping unit is directly coupled to the upper portion of the infrared temperature sensor, technical advantages in terms of material, process, and effect may be realized as compared with other inventions using the metal case. That is, while other inventions use the metal case in terms of the material, the present invention may use the capping unit using a silicon material or the like. Also, since the capping unit is included in a portion of a chip manufacturing process in terms of the process, the capping unit may be simply manufactured in the chip manufacturing process. However, other inventions using the metal case have a disadvantage that the capping unit has to be assembled one by one in a assembling process of each module after the chip manufacturing process. Furthermore, in view of an effect of improvement in accuracy of the temperature sensor, since the present invention is directly connected to the infrared temperature sensor, the thermal equilibrium state may be reached without the temperature difference. However, since a temperature difference due to a distance between the metal case and the infrared temperature sensor occurs other inventions using the metal case, there is a disadvantage in that the accuracy of the temperature measurement is deteriorated.

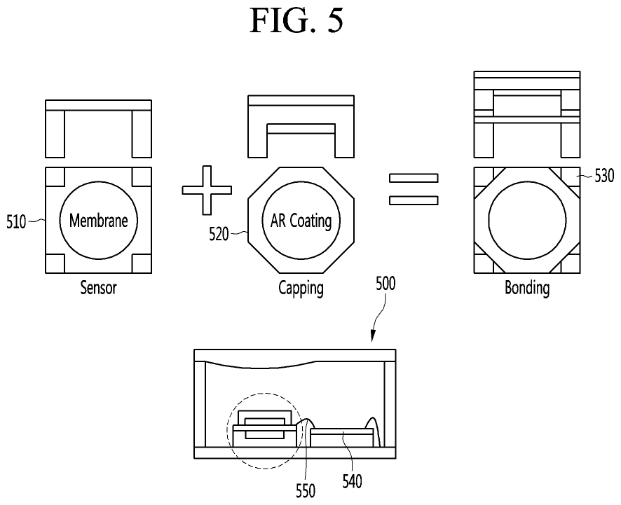

FIG. 5 is a view for explaining a method for connecting the infrared temperature sensor to the capping unit in the non-contact type infrared temperature sensor module according to an embodiment of the present invention.

As illustrated in FIG. 5, an infrared temperature sensor 510 of a non-contact type infrared temperature sensor module 500 according to an embodiment of the present invention may be coupled to a capping unit 520 to prevent air heat transmitted from an accommodation space within a case from being transmitted. According to an embodiment, as illustrated in FIG. 5, a bonding unit may be attached to a portion of the infrared temperature sensor 510, and the capping unit 520 may be coupled to a top surface of the infrared temperature sensor 510. Here, the infrared temperature sensor 510 may include a pad 530 on one area of a top surface of the infrared temperature sensor 510 so as to be electrically connected to a signal processing circuit 540 through a wire 550. Furthermore, the capping unit 520 may be designed in a shape that is different from that of the infrared temperature sensor 510 so as not to cover the pad 530.

Also, anti-reflection (AR) coating may be performed on the top surface of the capping unit 520. Thus, infrared rays detected by the infrared temperature sensor 510 may be prevented from being reflected.

As illustrated in FIG. 5, there is a technical effect that the heat transfer is blocked by coupling the capping unit to the upper surface of the infrared temperature sensor, and thus, the temperature measurement accuracy of the infrared temperature sensor is improved.

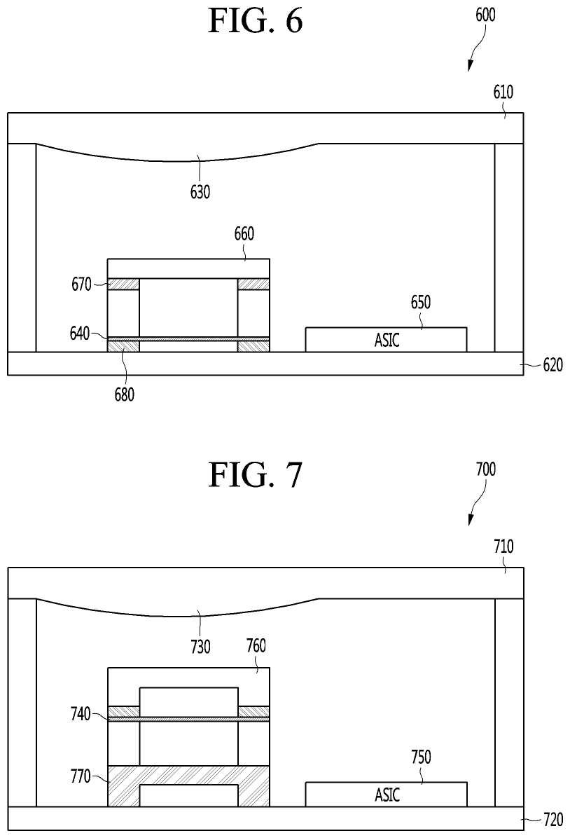

FIG. 6 is a view for explaining an example using a flip-chip type infrared temperature sensor in an infrared temperature sensor module according to another embodiment of the present invention.

As illustrated in FIG. 6, a non-contact type infrared temperature sensor module 600 according to another embodiment of the present invention may include a case 610 of which a portion of a top surface is opened and which has an accommodation space therein, a base 620 having a top surface coupled to the case 610, a cover window 630 installed on the top surface of the case 610 and configured to seal the opened portion of the case 610, a flip-chip type infrared temperature sensor 640 configured to detect a temperature of an object by receiving light transmitted from the cover window 630, and a first capping unit 660 coupled to an upper portion of the infrared temperature sensor 640 to block heat transmitted from the accommodation space. The non-contact type infrared temperature sensor module 600 of FIG. 6 may further include a signal processing circuit 650 electrically connected to the infrared temperature sensor 640 to detect a temperature detected by the infrared temperature sensor 640. Also, the first capping unit 660 and the infrared temperature sensor 640 may be connected to each other through a bonding unit 670, and the infrared temperature sensor 640 and the base 620 may be connected to each other through a metal bonding unit 680.

The non-contact type infrared temperature sensor module 600 is different from the non-contact type infrared temperature sensor module 500 of FIG. 4 according to an embodiment of the present invention in that the infrared temperature sensor 640 is provided in a flip-chip type. Since the infrared temperature sensor 640 is provided in the flip-chip type, an etching process may be omitted unlike the capping unit described with reference to FIG. 4 to cause an advantage of simplifying processes and reducing process costs.

FIG. 7 is a view for explaining an example in which the infrared temperature sensor module includes a first capping unit and a second capping unit according to an embodiment of the present invention.

As illustrated in FIG. 7, an infrared temperature sensor module 700 according to an embodiment of the present invention may include a case 710 of which a portion of a top surface is opened and which has an accommodation space therein, a base 720 having a top surface coupled to the case 710, a cover window 730 installed on the top surface of the case 710 and configured to seal the opened portion of the case 710, an infrared temperature sensor 740 configured to detect a temperature of an object by receiving light transmitted from the cover window 730, a first capping unit 760 coupled to an upper portion of the infrared temperature sensor 740 to block heat transmitted from the accommodation space, and a second capping unit 770 coupled to a lower portion of the infrared temperature sensor 740 to block heat transmitted from the top surface of the base 720.

As illustrated in FIG. 7, the infrared temperature sensor 740 of the infrared temperature sensor module 700 according to an embodiment of the present invention may have a top surface connected to the first capping unit 760 and a bottom surface connected to the second capping unit 770. The first capping unit 760, the infrared temperature sensor 740, and the second capping unit 770 may be in thermal equilibrium state through a thermally conductive manner. The first capping unit 760 may block transfer of air heat transmitted from the internal accommodation space within the case 710, and the second capping unit 770 may block transfer of air heat transmitted from an area of the top surface of the base 720. Due to such a design, the air heat transfer from the infrared temperature sensor may be more reliably blocked. Also, since the infrared temperature sensor detects only the temperature change due to the infrared rays introduced through a lens, there is a technical effect that accuracy of temperature measurement increases.

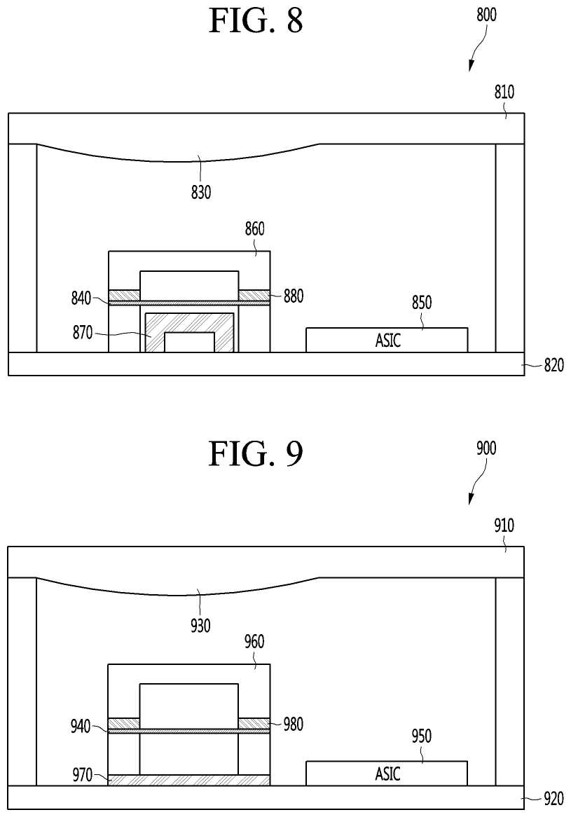

FIG. 8 is a view for explaining another example in which the infrared temperature sensor module includes the first capping unit and the second capping unit according to an embodiment of the present invention.

As illustrated in FIG. 8, an infrared temperature sensor module 800 according to an embodiment of the present invention may include a case 810 of which a portion of a top surface is opened and which has an accommodation space therein, a base 820 having a top surface coupled to the case 810, a cover window 830 installed on the top surface of the case 810 and configured to seal the opened portion of the case 810, an infrared temperature sensor 840 installed on the top surface of the base 820 and configured to detect a temperature of an object by receiving light transmitted from the cover window 830, a first capping unit 860 coupled to an upper portion of the infrared temperature sensor 840 to block heat transmitted from the accommodation space, and a third capping unit 870 coupled to the top surface of the base 820 in the accommodation space formed between the infrared temperature sensor 840 and the top surface of the base 820 to block heat transmitted from the accommodation space of the infrared temperature sensor 840.

As illustrated in FIG. 8, the infrared temperature sensor 840 of the infrared temperature sensor module 800 according to an embodiment of the present invention may form the accommodation space having a predetermined region when coupled to the top surface of the base 820.

As illustrated in FIG. 8, the infrared temperature sensor 840 of the infrared temperature sensor module 800 according to an embodiment of the present invention may have a top surface connected to the first capping unit 860 through a bonding unit 860 and a bottom surface connected to the base 820. On the other hand, the third capping unit 870 may not directly contact the infrared temperature sensor 840 but be connected to the top surface of the base 820 in the accommodation space formed between the infrared temperature sensor 840 and the base 820. The first capping unit 860 may block transfer of air heat transmitted from the accommodation space within the case 710, and the third capping unit 870 may block transfer of air heat transmitted from the accommodation space of the infrared temperature sensor 840. Due to such a design, the air heat transfer from the infrared temperature sensor may be more reliably blocked. Also, since the infrared temperature sensor detects only the temperature change due to the infrared rays introduced through a lens, there are technical effects that accuracy of temperature measurement increases, and the infrared temperature sensor is minimized in volume.

FIG. 9 is a view for explaining an example in which the infrared temperature sensor module includes the first capping unit and a metal plate according to an embodiment of the present invention.

An infrared temperature sensor module 900 according to an embodiment of the present invention may include a case 910 of which a portion of a top surface is opened and which has an accommodation space therein, a base 920 having a top surface coupled to the case 910, a cover window 930 installed on the top surface of the case 910 and configured to seal the opened portion of the case 910, an infrared temperature sensor 940 configured to detect a temperature of an object by receiving light transmitted from the cover window 930, a first capping unit 960 coupled to an upper portion of the infrared temperature sensor 940 to block transfer of heat transmitted from the accommodation space, and a metal plate 970 coupled to a lower portion of the infrared temperature sensor 940 and the top surface of the base 920 to prevent heat of the base 920 from being transferred to the infrared temperature sensor 940 and the first capping unit 960. The infrared temperature sensor module 900 of FIG. 9 may further include a signal processing circuit 950 electrically connected to the infrared temperature sensor 640 to detect a temperature detected by the infrared temperature sensor 640. Also, the first capping unit 960 and the infrared temperature sensor 970 may be connected to each other through a bonding unit 980.

As illustrated in FIG. 9, the metal plate 970 may be disposed on the bottom surface of the infrared temperature sensor 940 and the top surface of the base 920 to quickly reach a thermal equilibrium state in which temperatures of the base 920, the infrared temperature sensor 940, and the first capping unit 960 are uniform. Thus, there are technical effects that accuracy in temperature measurement of the infrared temperature sensor 940 increases, and also, the metal plate 970 is used to simplify a process, miniaturize the module, and reduce costs.

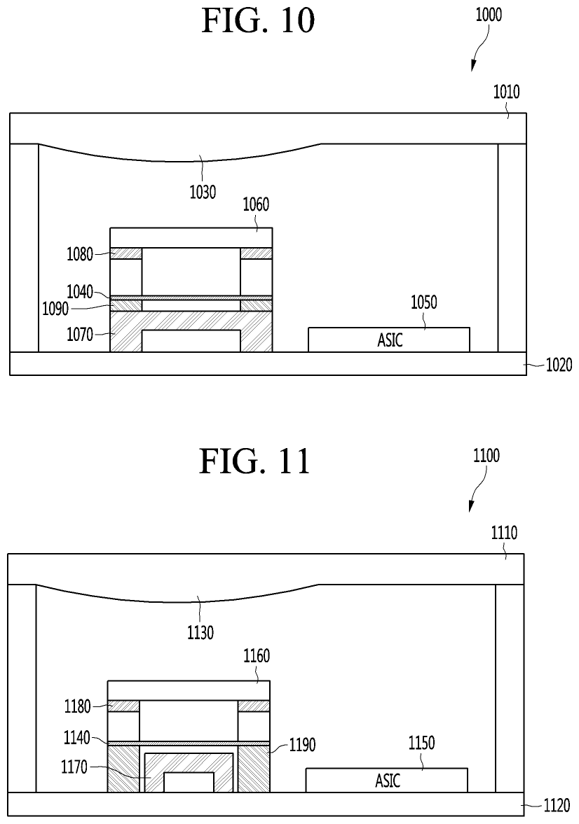

FIG. 10 is a view for explaining an example in which the infrared temperature sensor module includes a first capping unit and a second capping unit according to another embodiment of the present invention.

As illustrated in FIG. 10, an infrared temperature sensor module 1000 according to another embodiment of the present invention may include a case 1010 of which a portion of a top surface is opened and which has an accommodation space therein, a base 1020 having a top surface coupled to the case 1010, a cover window 1030 installed on the top surface of the case 1010 and configured to seal the opened portion of the case 1010, a flip-chip type infrared temperature sensor 1040 configured to detect a temperature of an object by receiving light transmitted from the cover window 1030, a first capping unit 1060 coupled to an upper portion of the infrared temperature sensor 1040 to block heat transmitted from the accommodation space, and a second capping unit 1070 coupled to a lower portion of the infrared temperature sensor 1040 through a metal bonding unit 1090 to block heat transmitted from the top surface of the base 1020. Also, the non-contact type infrared temperature sensor module 1000, may further include a signal processing circuit electrically connected to the infrared temperature sensor 1040 to detect a temperature detected by the infrared temperature sensor 1040. Also, the first capping unit 1060 and the infrared temperature sensor 1040 may be connected to each other through a bonding unit 1080.

As illustrated in FIG. 10, the infrared temperature sensor 1040 of the infrared temperature sensor module 1000 according to another embodiment of the present invention may be designed in a flip-chip shape and have a top surface connected to the first capping unit 1060 and a bottom surface connected to the second capping unit 1070 through the metal bonding unit 1090. The first capping unit 1060, the infrared temperature sensor 1040, and the second capping unit 1070 may be in thermal equilibrium state through a thermally conductive manner. The first capping unit 1060 may block transfer of air heat transmitted from the internal accommodation space within the case 1010, and the second capping unit 1070 may block transfer of air heat transmitted from an area of the top surface of the base 1020. Due to such a design, the air heat transfer from the infrared temperature sensor may be more reliably blocked. Also, since the infrared temperature sensor detects only the temperature change due to the infrared rays introduced through a lens, there is a technical effect that accuracy of temperature measurement increases.

FIG. 11 is a view for explaining another example in which the infrared temperature sensor module includes the first capping unit and the second capping unit according to another embodiment of the present invention.

As illustrated in FIG. 11, an infrared temperature sensor module 1100 according to another embodiment of the present invention may include a case 1110 of which a portion of a top surface is opened and which has an accommodation space therein, a base 1120 having a top surface coupled to the case 1110, a cover window 1130 installed on the top surface of the case 1110 and configured to seal the opened portion of the case 1110, a flip-chip type infrared temperature sensor 1140 configured to detect a temperature of an object by receiving light transmitted from the cover window 1130, a first capping unit 1160 coupled to an upper portion of the infrared temperature sensor 1140 to block heat transmitted from the accommodation space, and a third capping unit 1170 coupled to the top surface of the base 1120 in the accommodation space formed by connecting the infrared temperature sensor 1130 to th top surface of the base 1120 by using a bonding material 1190 to block heat transferred from the accommodation space of the infrared temperature sensor 1140.

As illustrated in FIG. 11, the infrared temperature sensor 1140 of the infrared temperature sensor module 1100 according to another embodiment of the present invention may have a top surface connected to the first capping unit 1160 and a bottom surface connected to the base 1120 through the bonding material 1190. On the other hand, the third capping unit 1170 may not directly contact the infrared temperature sensor 1140 but be connected to the top surface of the base 1120 in the accommodation space formed between the infrared temperature sensor 1140 and the base 1120. The first capping unit 1160 may block transfer of air heat transmitted from the internal accommodation space within the cover 1110, and the third capping unit 1170 may block transfer of air heat transmitted from an area of the top surface of the base 1120. Due to such a design, the air heat transfer from the infrared temperature sensor may be more reliably blocked. Also, since the infrared temperature sensor detects only the temperature change due to the infrared rays introduced through a lens, there are technical effects that accuracy of temperature measurement increases, and the infrared temperature sensor is minimized in volume.

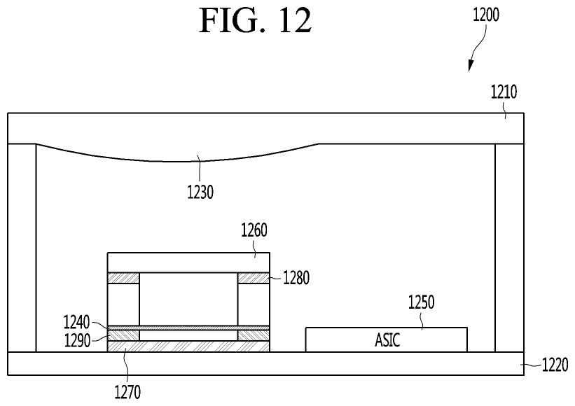

FIG. 12 is a view for explaining an example in which the infrared temperature sensor module includes the first capping unit and a metal plate according to another embodiment of the present invention.

As illustrated in FIG. 12, a non-contact type infrared temperature sensor module 1200 according to another embodiment of the present invention may include a case 1210 of which a portion of a top surface is opened and which has an accommodation space therein, a base 1220 having a top surface coupled to the case 1210, a cover window 1230 installed on the top surface of the case 1210 and configured to seal the opened portion of the case 1210, a flip-chip type infrared temperature sensor 1240 configured to detect a temperature of an object by receiving light transmitted from the cover window 1230, a first capping unit 1260 coupled to an upper portion of the infrared temperature sensor 1240 to block transfer of heat transmitted from the accommodation space, and a metal plate 1270 coupled to a lower portion of the infrared temperature sensor 1240 and the top surface of the base 1220 to prevent heat of the base 1220 from being transferred to the infrared temperature sensor 1240 and the first capping unit 1260.

As illustrated in FIG. 12, the metal plate 1270 may be disposed on the bottom surface of the infrared temperature sensor 1240 and the top surface of the base 1220 to quickly reach a thermal equilibrium state in which temperatures of the base 1220, the infrared temperature sensor 1240, and the first capping unit 1260 are uniform. Thus, there are technical effects that accuracy in temperature measurement of the infrared temperature sensor 1240 increases, and also, the metal plate 1270 is used to simplify a process, miniaturize the module, and reduce costs. The metal plate may be realized in a metal sheet manner.

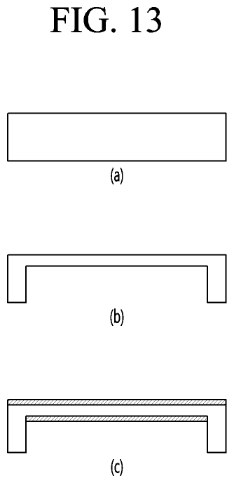

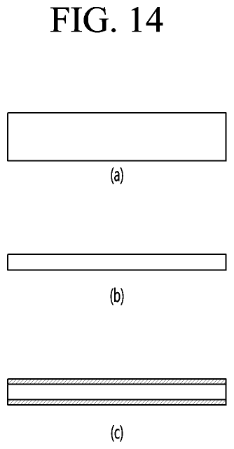

FIGS. 13 and 14 are views for explaining an example in which an anti-reflection filter is attached to the first capping unit of the infrared temperature sensor module according to an embodiment of the present invention.

FIG. 13 is a view for exampling an example of manufacturing the first capping unit of FIG. 4. Here, after a silicon wafer of FIG. 13A is etched as illustrated in FIG. 13B, an anti-reflection filter may be applied, deposited, or attached as illustrated in FIG. 13C. Furthermore, FIG. 14 is a view for exampling an example of manufacturing the first capping unit of FIG. 6. Here, after a silicon wafer of FIG. 14A is etched as illustrated in FIG. 14B, an anti-reflection filter may be applied, deposited, or attached as illustrated in FIG. 14C.

As described above, since the anti-reflection filter is applied or deposited on the first capping unit, light in an infrared region may not be reflected but be well absorbed to assist accurate sensing of the infrared temperature sensor.

FIG. 15 is a view for explaining a first embodiment in which an infrared temperature sensor and a signal processing circuit are disposed on different surfaces of a base in the infrared temperature sensor module according to the present invention.

As illustrated in FIG. 15, an infrared temperature sensor module according to an embodiment of the present invention may include a cover 1510, a lens 1512, a case 1520, an infrared temperature sensor 1530, a base 1540, a signal processing circuit (ASIC) 1550, a solder ball 1560, and a molding unit 1570. Furthermore, although not shown in FIG. 15, the non-contact type infrared temperature sensor module 1500 according to an embodiment of the present invention may include a heat dissipation structure on a pad portion on which the infrared temperature sensor 1530 and the signal processing circuit 1550 are seated on the base 1540 so as to accurately measure a temperature by minimizing an effect of heat generated in the infrared temperature sensor 1530 and the signal processing circuit 1550.

The cover 1510 of the non-contact type infrared temperature sensor module 1500 according to an embodiment of the present invention may be partially opened to form an opening so that light is incident from the outside and include a reflective lens or a diffractive lens 1512 to collect light while sealing the opening of the cover 1510 on top and bottom surfaces thereof. The 1510 may be made of single crystal silicon, chalcogenide glass, sapphire glass, plastic, or a combination of the materials. The cover 1510 may include a transmission filter that selectively transmits only infrared rays to one surface or both surfaces thereof while suppressing surface reflection.

Also, the non-contact type infrared temperature sensor module 1500 according to an embodiment of the present invention may include a case 1520 that is coupled to a bottom surface of the cover 1510 to form an internal space or an accommodation space of the infrared temperature sensor module 1500. The case 1520 may be made of a metal such as zinc, aluminum, copper, nickel, iron, stainless steel, or a material such as monocrystalline silicon ceramic or plastic. The case 1520 may be integrated with the cover 1510 to form an outer appearance of the infrared temperature sensor module 1500. In this case, a through-hole or an opening through which infrared rays are transmitted may be formed in an upper portion of the case 1520, and an infrared filter or a lens may be mounted in a manner of sealing the through-hole or the opening. Also, the internal space of the infrared temperature sensor module 1500 may be filled with nitrogen, argon, or dry air at normal pressure, and the internal space may become a vacuum state of 50 Torr or 100 Torr or less.

The infrared temperature sensor module 1500 according to an embodiment of the present invention may include a base 1540 which is coupled to a bottom surface of the base 1520 and on which the infrared temperature sensor 1530 and the signal processing circuit 1550 are mounted. A through-hole or an opening for electrical connection to a wafer-shaped substrate polished to a uniform thickness on both surfaces with a material such as silicon, glass, metal, or ceramic may be formed in the base 1540. If necessary, an insulation layer may be formed on an entire surface to fill the through-hole or the opening with a metal. Also, an electrical wire for facilitating the electrical connection may be formed on the top and bottom surfaces of the base 1540. The base 1540 and the case 1520 may be connected to each other through a bonding unit. Also, the base 1540 may have a uniform length of a vertical width without having a protrusion.

The infrared temperature sensor module 1500 according to an embodiment of the present invention may include an infrared temperature sensor 1530 that detects infrared rays passing through the cover 1510 to measure a temperature. In the infrared temperature sensor 1530, a plurality of thermal infrared detectors may be disposed on one surface of a semiconductor substrate. When the surface of the infrared temperature sensor 1530 on which the infrared detectors are disposed faces an upper side and is coupled to the top surface of the base 1540, the sensed results may be transmitted to the signal processing circuit 1550 in a manner of connecting a signal electrode by using a gold or aluminum wire. Also, when the surface of the infrared temperature sensor 1530 on which the infrared detectors are disposed faces a lower side and is coupled to the top surface of the base 1540, the sensed results may be transmitted to the signal processing circuit 1550 an a manner of connecting the signal electrode by using a solder ball or a metal bump.

The infrared temperature sensor module 1500 according to an embodiment of the present invention may include a signal processing circuit 1550 for processing the results sensed by the infrared temperature sensor 1530. The signal processing circuit 1550 may be coupled to the bottom surface of the base 1540. The signal processing circuit 1550 may perform a function of processing a signal transmitted from the infrared temperature sensor 1530 and performing temperature correction. Also, the signal processing circuit 1550 may connect the signal electrode to the base 1540 by using the gold or aluminum wire when the surface on which is electrode is formed is coupled to the bottom surface of the base 1540 to face an external PCB. Also, the signal processing circuit 1550 may connect the signal electrode to the base 1540 by using the solder ball or the metal bump when the surface on which is electrode is formed is coupled to the bottom surface of the base 1540 to face the base 1540.

The solder ball 1560 attached to the bottom surface of the base 1540 of the infrared temperature sensor module 1500 according to an embodiment of the present invention may have a spherical shape, a cylindrical shape, a rectangular parallelepiped shape, or the like.

The cover 1510 and the case 1520 and also the case 1520 and the base 1540 of the infrared temperature sensor module 1500 according to an embodiment of the present invention may be connected to each other a bonding unit 1580. The bonding unit 1580 may be made of a bonding material such as a metal, a ceramic, or an organic compound, or a combination thereof and may be bonded through a melting or baking, thermosetting, or photo-curing process.

As illustrated in FIG. 15, the infrared temperature sensor 1530 and the signal processing unit 1550 of the infrared temperature sensor module 1500 according to an embodiment of the present invention may be mounted to face the top and bottom surfaces of the base 1540 having the through-hole or the opening, which is filled with the metal. A metal part for facilitating electrical connection of the infrared temperature sensor 1530 and the signal processing circuit 1550 may be mounted on the top and bottom surfaces of the base 1540. Also, the metal part may be coupled to the bottom surface of the base 1540 to perform electrical connection between the infrared temperature sensor module 1500 and a PCB, and at least four solder balls 1560 may be provided to constantly maintain a distance between the signal processing circuit 1550 and the PCB. Also, an insulation part 1562 disposed in the vicinity of the solder ball 1560 may be disposed on the bottom surface of the base 1540. Also, as illustrated in FIG. 15, the infrared temperature sensor module 1500 according to an embodiment of the present invention may include a molding part that surrounds the signal processing circuit 1550 to protect the signal processing circuit 1550 against external environments and assist heat dissipation.

When the infrared temperature sensor module is manufactured as illustrated in FIG. 15, there is a technical advantage in that a package size may be minimized to be effectively mounted on a mobile or wearable device.

Also, when the infrared temperature sensor module is manufactured as illustrated in FIG. 15, there is a technical advantage in that the infrared temperature sensor and the signal processing circuit are separately disposed on the top and bottom surfaces of the base to suppress signal non-uniformity of the infrared temperature sensor due to heat generation of the signal processing circuit.

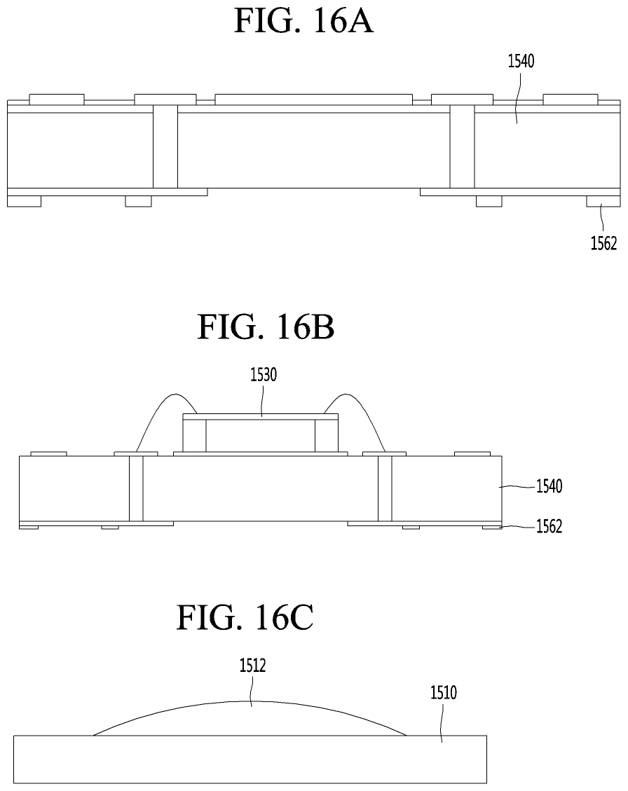

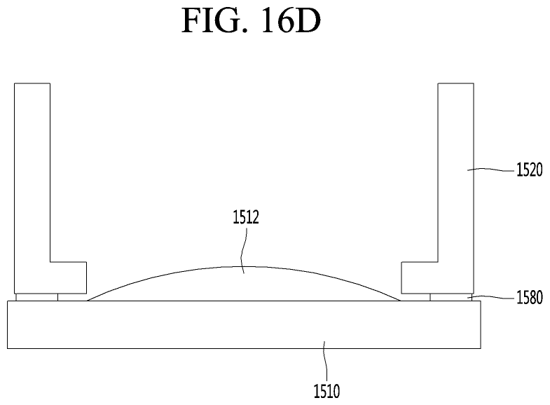

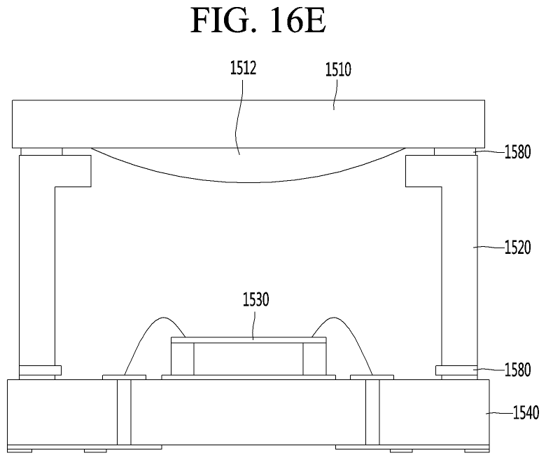

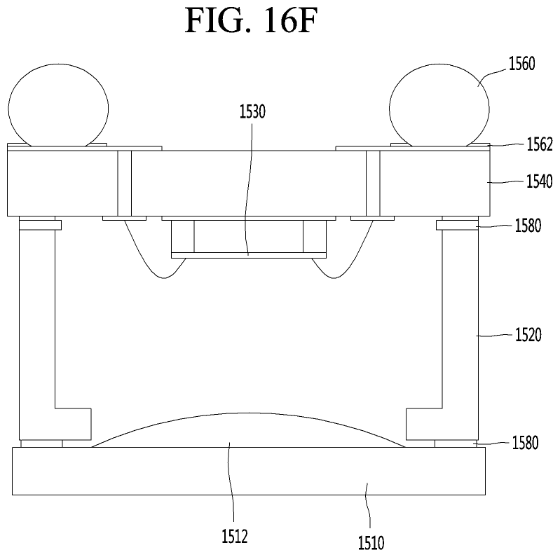

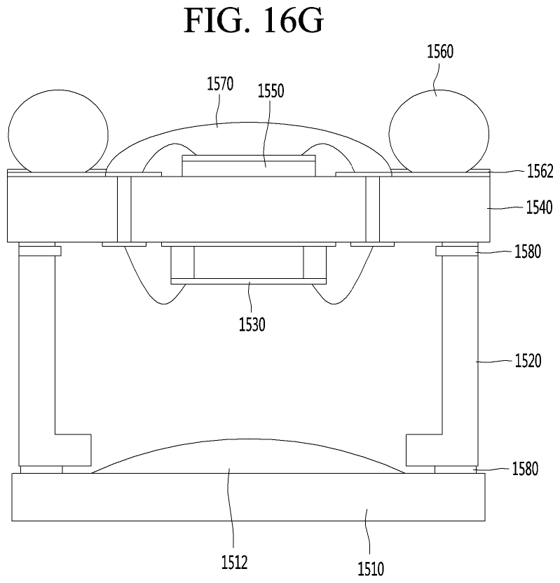

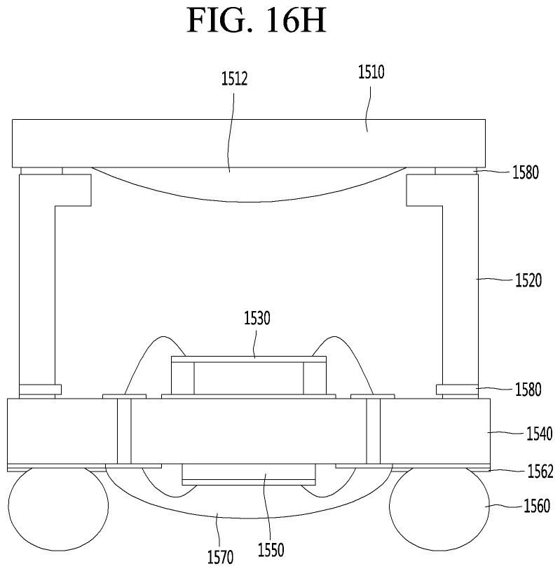

FIGS. 16A to 16H are views for explaining a process of manufacturing an infrared temperature sensor module in which an infrared temperature sensor and a signal processing circuit are disposed on different surfaces of a base according to the present invention.

As illustrated in FIG. 16A, to manufacture the non-contact type infrared temperature sensor module 1500 according to an embodiment of the present invention, first, a wafer-shaped base 1540 or a substrate may be manufactured. Here, a through-hole or an opening may be formed in a portion of the base and be filled with a metal. Also, a metal part for electrical connection between the infrared temperature sensor and the signal processing circuit may be mounted on a top or bottom surface of the base. Also, an insulation part 1562 for manufacturing a solder ball to be mounted on the bottom surface of the base may be manufactured in this process.

As illustrated in FIG. 16B, after the base 1540 is manufactured, the infrared temperature sensor 1530 may be mounted on the top surface of the base 1540. As illustrated in FIG. 16B, when the infrared temperature sensor 1530 is mounted to face the infrared detector, a signal electrode may be connected to the metal part of the base by using a gold or aluminum wire.

Then, as illustrated in FIG. 16C, a cover 1510 and a lens 1512 may be manufactured in the form of a wafer. In this case, since the lens 1512 is mounted on one surface of the cover 1510, and then, the cover 1510 is mounted from a rear side, the lens 1512 may be included in an internal space of the infrared temperature sensor module 1500 and be exposed to the outside of the infrared temperature sensor module 1500.

In the next process, as illustrated in FIG. 16D, the case 1520 may be coupled to one surface of the cover 1510 by using a bonding unit 1580.

In the next process, as illustrated in FIG. 16E, an assembly of the case 1520 and the cover 1510, which are coupled to each other in FIG. 16D, may be coupled to the top surface of the base 1540. In this case, the bottom surface of the case 1520 and the top surface of the base 1540 may be coupled to each other. In the process of FIG. 16E, an internal space or an accommodation space may be formed. Also, since the infrared temperature sensor 1530 is mounted in the internal space in this process, the infrared temperature sensor 1530 may be blocked from external environments to improve accuracy in temperature measurement.

In the next process, as illustrated in FIG. 16F, the solder ball 1560 may be mounted on the bottom surface of the base 1540 in a state in which the assembly according to the process of FIG. 16E is turned upside down. In this case, in the process of FIG. 16A, the solder ball 1560 may be mounted on an area on which the insulation part 1652 is mounted.

In the next process, as illustrated in FIG. 16G, the signal processing circuit 1550 may be mounted on the bottom surface of the base 1540, and a molding part 1570 for protecting the signal processing circuit 1550 from the external environment and releasing heat generated from the signal processing circuit 1550 may be mounted.

Finally, as illustrated in FIG. 16H, when the assembly of FIG. 16G is turned upside down, the non-contact type infrared temperature sensor module 1500 finally mounted on a PCB may be completed.

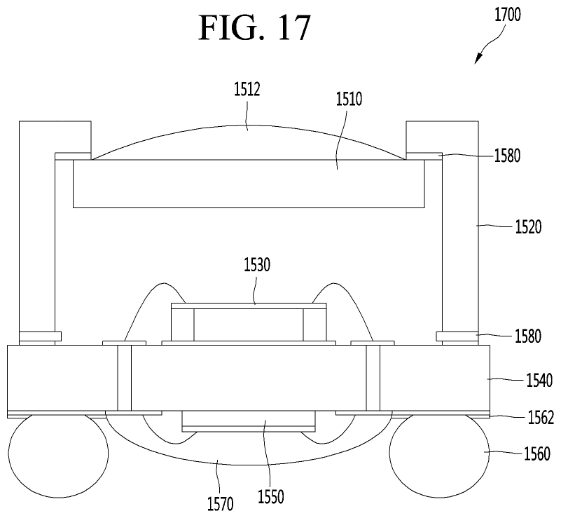

FIG. 17 is a view for explaining a second embodiment in which an infrared temperature sensor and a signal processing circuit are disposed on different surfaces of a base in the infrared temperature sensor module according to the present invention.

Unlike the non-contact type infrared temperature sensor module 1500, in the non-contact type infrared temperature sensor module 1700 of FIG. 17, a lens 1520 may be disposed on the top surface of the cover 1510 so as to be exposed to the outside of the infrared temperature sensor module 1700. This design change may be simply achieved when the coupling process is performed in the state in which the lens 1520 is turned upside down to be exposed to the outside while the lens 1520 mounted on the one surface of the cover 1510 in the above-described process of FIG. 16C is used as it is in the infrared temperature sensor module 1700. The non-contact type infrared temperature sensor module 1700 of FIG. 17 has the same structure and function as the non-contact type infrared temperature sensor module 1500 of FIG. 15 except that the lens 1520 is exposed to the outside, and thus, its duplicated description will be omitted.

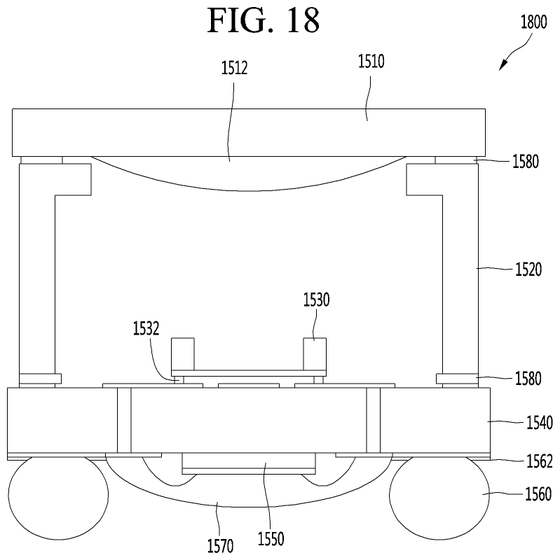

FIG. 18 is a view for explaining a third embodiment in which an infrared temperature sensor and a signal processing circuit are disposed on different surfaces of a base in the infrared temperature sensor module according to the present invention.

Unlike the non-contact type infrared temperature sensor module 1500 of FIG. 15, a non-contact type infrared temperature sensor module 1800 of FIG. 18 includes a flip-chip type infrared temperature sensor 1530. In this case, since an infrared detector of the infrared temperature sensor 1530 is mounted to face a base 1540, the infrared temperature sensor 1530 may be connected to a top surface of the base 1540 through a solder ball or a metal bump 1532, unlike the wire of the non-contact type infrared temperature sensor module 1500 of FIG. 15. The flip-chip type infrared temperature sensor 1530 may have the same shape as that of FIG. 6, and thus, its duplicated description will be omitted. Also, the non-contact type infrared temperature sensor module 1800 of FIG. 18 has the same structure and function as the non-contact type infrared temperature sensor module 1500 of FIG. 15 except that the infrared temperature sensor 1530 is provided in the flip-chip type, and the solder ball or the metal bump 1532 is used, and thus, its duplicated description will be omitted.

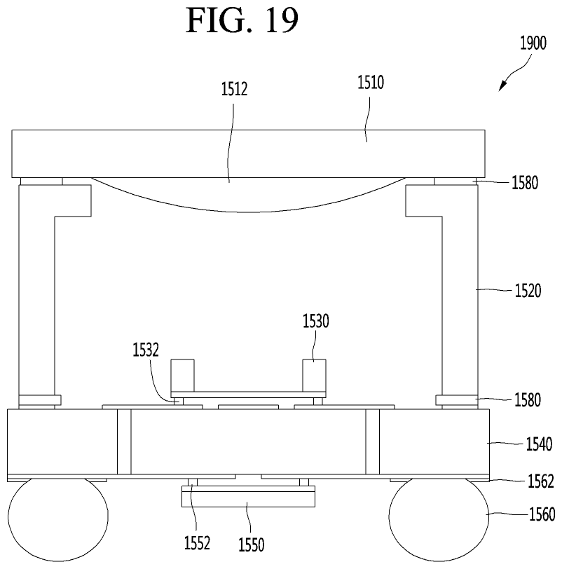

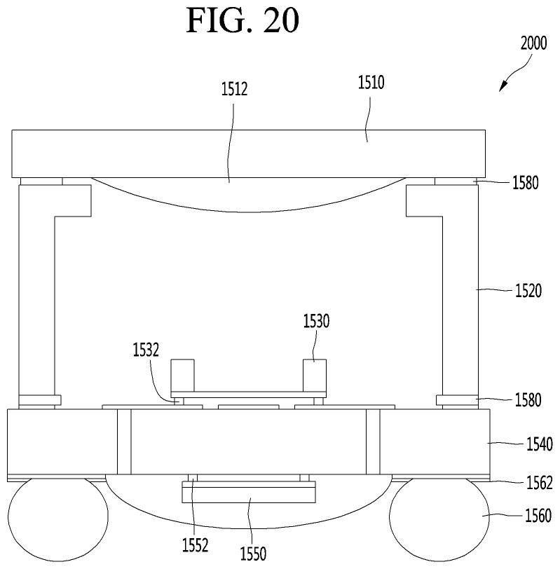

FIGS. 19 and 20 are views for explaining a fourth embodiment in which an infrared temperature sensor and a signal processing circuit are disposed on different surfaces of a base in the infrared temperature sensor module according to the present invention.

Unlike the non-contact type infrared temperature sensor module 1500 of FIG. 15, a non-contact type infrared temperature sensor module 1900 of FIG. 19 includes a flip-chip type infrared temperature sensor 1530 and a flip-chip type signal processing circuit 1550. In this case, since an infrared detector of the infrared temperature sensor 1530 is mounted to face a base 1540, the infrared temperature sensor 1530 may be connected to a top surface of the base 1540 through a solder ball or a metal bump 1532, unlike the wire of the non-contact type infrared temperature sensor module 1500 of FIG. 15. Similarly, since an electrode of the signal processing circuit 1550 is mounted to face a base 1540, the signal processing circuit 1550 may be connected to a bottom surface of the base 1540 through a solder ball or a metal bump 1552, unlike the wire of the non-contact type infrared temperature sensor module 1500 of FIG. 15. Also, the non-contact type infrared temperature sensor module 1900 of FIG. 19 has the same structure and function as the non-contact type infrared temperature sensor module 1500 of FIG. 15 except that each of the infrared temperature sensor 1530 and the signal processing circuit 1550 is provided in the flip-chip type, and the solder balls or the metal bumps 1532 and 1552 are used, and thus, its duplicated description will be omitted.

Also, in a non-contact type infrared temperature sensor module 2000 of FIG. 20, a molding part 1570 for protecting the signal processing circuit 1550 of the non-contact type infrared temperature sensor module 1900 of FIG. 19 is additionally provided. Here, the molding part 1570 may be added whether the signal processing circuit 1550 is coupled to the base 1540 in any manner. Other structures and functions are the same as those of the non-contact type infrared temperature sensor modules of FIGS. 15 and 19, and thus, their duplicated description will be omitted.

The above-described NON-CONTACT INFRARED TEMPERATURE SENSOR MUDULE is not limited to the application of the configurations and methods of the above-described embodiments and the entire or part of the embodiments can be selectively combined and configured to allow various modifications.

1. A non-contact type infrared temperature sensor module comprising:
a case having a top surface and an accommodation space therein, a portion of the top surface being opened;
a base having a top surface coupled to the case;
a cover window installed on the top surface of the case and configured to seal the opened portion of the case;
an infrared temperature sensor configured to detect a temperature by receiving light transmitted from the cover window; and
a first capping unit coupled to an upper portion of the infrared temperature sensor.

2. The non-contact type infrared temperature sensor module according to claim 1, further comprising a signal processing circuit electrically connected to the infrared temperature sensor to receive and process a signal of the temperature detected by the infrared temperature sensor,
wherein the first capping unit and the infrared temperature sensor are connected to each other through a bonding unit.

3. The non-contact type infrared temperature sensor module according to claim 1, further comprising a second capping unit coupled to a lower portion of the infrared temperature sensor.

4. The non-contact type infrared temperature sensor module according to claim 1, wherein the infrared temperature sensor is connected to the top surface of the base and forms the accommodation space, and
the non-contact type infrared temperature sensor module further comprises a third capping unit coupled to the top surface of the base in the accommodation space of the infrared temperature sensor.

5. The non-contact type infrared temperature sensor module according to claim 1, further comprising a metal plate coupled to a lower portion of the infrared temperature sensor and coupled to the top surface of the base.

6. The non-contact type infrared temperature sensor module according to claim 1, further comprising an anti-reflection filter attached to the first capping unit and configured to prevent light in an infrared region from being reflected.

7. A non-contact type infrared temperature sensor module comprising:
a case having a top surface, a portion of the top surface being opened;
a base having a top surface coupled to the case;
a cover window installed on the top surface of the case and configured to cover the opened portion of the case;
a flip-chip type infrared temperature sensor configured to detect a temperature by receiving light transmitted from the cover window; and
a first capping unit coupled to the flip-chip type infrared temperature sensor.

8. The non-contact type infrared temperature sensor module according to claim 7, further comprising a signal processing circuit electrically connected to the flip-chip type infrared temperature sensor to receive and process a signal of the temperature detected by the flip-chip type infrared temperature sensor,
wherein the first capping unit and the flip-chip type infrared temperature sensor are connected to each other through a bonding unit, and
the flip-chip type infrared temperature sensor and the base are connected to each other through a metal bonding unit.

9. The non-contact type infrared temperature sensor module according to claim 7, further comprising a second capping unit coupled to a lower portion of the flip-chip type infrared temperature sensor through a metal bonding unit.

10. The non-contact type infrared temperature sensor module according to claim 7, wherein the flip-chip type infrared temperature sensor is connected to the top surface of the base by using a bonding material and forms an accommodation space, and
the non-contact type infrared temperature sensor module further comprises a third capping unit coupled to the top surface of the base in the accommodation space of the flip-chip type infrared temperature sensor.

11. The non-contact type infrared temperature sensor module according to claim 7, further comprising a metal plate coupled to a lower portion of the flip-chip type infrared temperature sensor and coupled to the top surface of the base.

12. The non-contact type infrared temperature sensor module according to claim 7, further comprising an anti-reflection filter attached to the first capping unit and configured to prevent light in an infrared region from being reflected.

13. The non-contact type infrared temperature sensor module according to claim 1, wherein the cover window includes a lens or an infrared filter.

14. The non-contact type infrared temperature sensor module according to claim 1, wherein the first capping unit is bonded to the infrared temperature sensor by using a glass frit bonding, a metal bonding, or an adhesive bonding.

15. The non-contact type infrared temperature sensor module according to claim 3, wherein the first capping unit blocks transfer of air heat transmitted from the accommodation space of the case, and the second capping unit blocks transfer of air heat transmitted from an area of the top surface of the base.

16. The non-contact type infrared temperature sensor module according to claim 1, wherein the infrared temperature sensor includes a plurality of thermal infrared detectors disposed on one surface of a semiconductor substrate.

17. The non-contact type infrared temperature sensor module according to claim 1, further comprising a signal processing circuit electrically connected to the infrared temperature sensor to process a signal of the temperature detected by the infrared temperature sensor,
wherein the infrared temperature sensor is disposed on the top surface of the base and the signal processing circuit is disposed on a bottom surface of the base.

18. The non-contact type infrared temperature sensor module according to claim 7, wherein the cover window includes a lens or an infrared filter.

19. The non-contact type infrared temperature sensor module according to claim 7, wherein the flip-chip type infrared temperature sensor includes a plurality of thermal infrared detectors disposed on one surface of a semiconductor substrate.

20. The non-contact type infrared temperature sensor module according to claim 7, further comprising a signal processing circuit electrically connected to the flip-chip type infrared temperature sensor to process a signal of the temperature detected by the flip-chip type infrared temperature sensor,
wherein the flip-chip type infrared temperature sensor is disposed on the top surface of the base and the signal processing circuit is disposed on a bottom surface of the base.
